(19) United States
(12) Patent Application Publication
(10) Pub. No.: US 2009/0316203 A1
(43) Pub. Date: Dec. 24, 2009

(54) FAX TRANSMISSION SERVICE

(76) Inventors: Michael A. Dukie, Palm Harbor, FL (US); John Dutchak, Tampa, FL (US)

Correspondence Address: FRASER CLEMENS MARTIN & MILLER LLC, 28366 KENSINGTON LANE, PERRYSBURG, OH, 43551, US

(21) Appl. No.: 12/487,028

(22) Filed: Jun. 18, 2009

Related U.S. Application Data
(60) Provisional application No. 61/073,495, filed on Jun. 18, 2008.

(51) Int. Cl. G06F 3/12

(52) U.S. Cl. 358/1.15

(57) ABSTRACT

A facsimile communication system and method for receiving an electronic facsimile, wherein the facsimile communication system provides access to the received electronic facsimile to a desired recipient having access to the internet, is disclosed. The facsimile communication system includes a facsimile device adapted to transmit an electronic facsimile a server system having a server input adapted to receive the electronic facsimile, a processor adapted to convert the electronic facsimile into a converted facsimile having a desired format and a database adapted to store the converted facsimile, and a user system adapted to access the database for retrieving the converted facsimile.

### CROSS-REFERENCE TO RELATED APPLICATION

This application claims the benefit of U.S. Provisional Patent Application No. 61/073,495 filed on Jun. 18, 2008.

### FIELD OF THE INVENTION

The present invention generally relates to a system and method for receiving electronic facsimiles. In particular, the invention is directed to a facsimile server system for receiving and converting electronic facsimiles.

### BACKGROUND OF THE INVENTION

The means by which people communicate is constantly evolving. However, a facsimile machine continues to be a standard communication device in many businesses throughout the world. Unfortunately, for a small business or for a private household, a facsimile machine is an expensive piece of equipment. In addition to the cost of purchasing the facsimile machine, the facsimile machine also requires toner, paper maintenance, as well as possible repairs. These expenses may be large enough to prevent many of the small businesses and certainly many households from benefiting from the service that the facsimile machine can provide.

Alternatively, a personal computer (PC) may be employed for the sending and/or the receiving facsimile machine. Where a PC is employed, the PC must be provided with a facsimile compatible modem and translation software for converting a document from and to a facsimile transmission format. Whether a conventional facsimile machine or a PC is employed, a facsimile receiver must provide the facsimile sender with a telephone number to send the facsimile to. The facsimile sender, thus, must know precisely where the receiver will be located in order to receive a transmission. This is especially inconvenient for business travelers who, in order to receive facsimile transmissions, must supply facsimile numbers at a work location and possibly at a hotel.

It would be desirable to develop a facsimile communication system and method for receiving an electronic facsimile, wherein the facsimile communication system provides access to the received electronic facsimile to a desired recipient having access to the Internet.

### SUMMARY OF THE INVENTION

Concordant and consistent with the present invention, a facsimile communication system and method for receiving an electronic facsimile, wherein the facsimile communication system provides access to the received electronic facsimile to a desired recipient having access to the Internet, has surprisingly been discovered.

In one embodiment, a facsimile server system comprises a server input adapted to receive an electronic facsimile, a processor adapted to convert the electronic facsimile into a converted facsimile having a desired format, and a database adapted to store the converted facsimile

In another embodiment, a facsimile communication system comprises a facsimile device adapted to transmit an electronic facsimile, a server system having a server input adapted to receive the electronic facsimile, a processor adapted to convert the electronic facsimile into a converted facsimile having a desired format and a database adapted to store the converted facsimile, and a user system adapted to access the database for retrieving the converted facsimile.

The invention also provides methods for receiving an electronic facsimile.

One method comprises the steps of: transmitting an electronic facsimile having a Tagged Image File format; providing a server system having a server input adapted to receive the electronic facsimile, a processor adapted to convert the electronic facsimile into a converted facsimile having a desired format and a web-accessible database adapted to store the converted facsimile; converting the electronic facsimile into a converted facsimile having a Portable Document Format; storing the converted facsimile on the database; and transmitting the converted facsimile as an attachment in an electronic mail.

### BRIEF DESCRIPTION OF THE DRAWINGS

The above, as well as other advantages of the present invention, will become readily apparent to those skilled in the art from the following detailed description of the preferred embodiment when considered in the light of the accompanying drawings in which:

FIG. 1 is a schematic block diagram of a facsimile communication system according to an embodiment of the present invention.

FIG. 2 is a flow chart of a method for receiving an electronic facsimile according to an embodiment of the present invention.

### DETAILED DESCRIPTION OF EXEMPLARY EMBODIMENTS OF THE INVENTION

The following detailed description and appended drawings describe and illustrate various embodiments of the invention. The description and drawings serve to enable one skilled in the art to make and use the invention, and are not intended to limit the scope of the invention in any manner. In respect of the methods disclosed, the steps presented are exemplary in nature, and thus, the order of the steps is not necessary or critical.

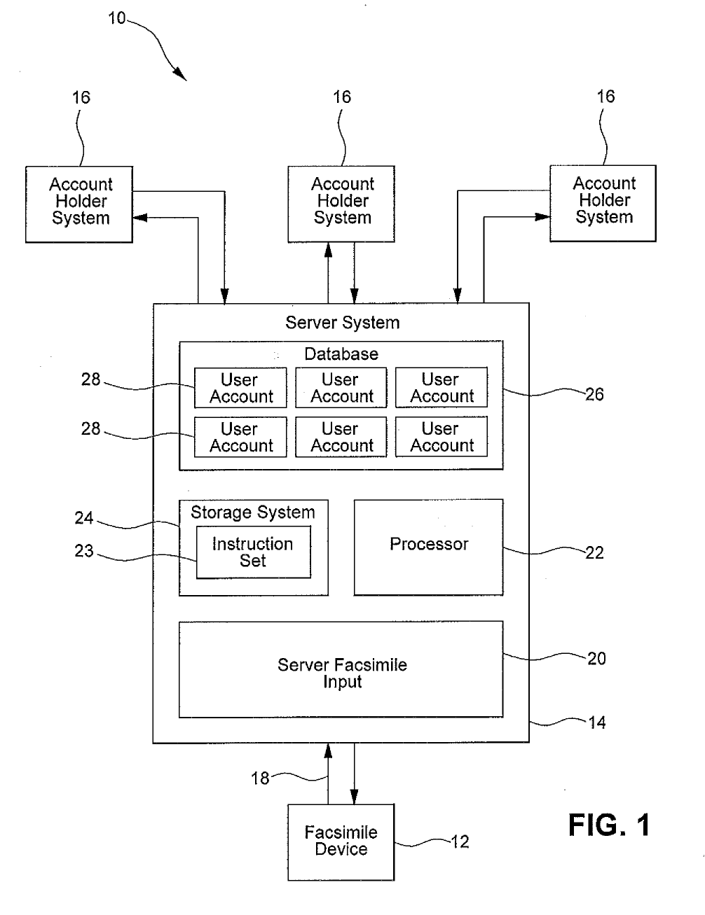

FIG. 1 shows a facsimile communication system 10 according to an embodiment of the present invention. The facsimile communication system 10 includes a facsimile device 12, a server system 14, and an account holder system 16.

The facsimile device 12 is adapted to communicate with the server system 14 by at least one of a telephone line and a high speed internet line. Other means of establishing an electronic communication may be used, as desired. The facsimile device 12 is further adapted to electronically transmit a facsimile 18 to the server system 14 through at least one of the telephone line and the high speed internet line. Typically, the facsimile 18 is transmitted and received in a Tagged Image File (TIF) format. However, it is understood that other formats may be used, as desired. In certain embodiments, the facsimile device 12 is a conventional fax machine. However, other devices adapted to convert a hard copy into an electronic facsimile and transmit the facsimile may be used, as desired.

The server system 14 includes a server facsimile input 20, a processor 22, a storage system 24, and a database 26. It is understood that the server system 14 may include additional components, as desired.

The server facsimile input 20 is adapted to communicate with at least one facsimile device 12 through at least one of the telephone line and the high speed internet line. The server facsimile input 20 is further adapted to receive the incoming electronic facsimile 18. It is understood that the server facsimile input 20 may be adapted to communicate with any number of facsimile devices 12 and receive any number of electronic facsimiles 18, as desired. In one embodiment, the server facsimile input 20 is a conventional voice/fax card integrated with the server system 14. However, other devices adapted to receive the electronic facsimile 18 may be used, as desired.

The processor 22 is adapted to convert the facsimile 18 based upon an instruction set 23. The instruction set 23, which may be embodied within any computer readable medium, includes processor executable instructions for configuring the processor 22 to perform a variety of tasks. The processor 22 may also be adapted to perform operations such as, an e-mail transmission, a user query, a data transfer, a data retrieval, a data processing, and a user account management for example. It is understood that other devices may be used to manage the data stored in the database 26 such as a software engine and a software package, for example. The storage system 24 may be a single storage device or may be multiple storage devices. Portions of the storage system 24 may also be located on the processor 22. Furthermore, the storage system 24 may be a solid state storage system, a magnetic storage system, an optical storage system or any other suitable storage system. It is understood that the storage system 24 is adapted to store the instruction set 23. Other data and information may be stored in the storage system 24, as desired.

The database 26 is in communication with the processor 22. The database 16 is adapted to store information in an electronic medium. As shown, the database 26 includes a plurality of user accounts 28. Each of user accounts 28 is associated with a pre-registered account of a particular user or “account holder”. Each of the user accounts 28 is also associated with a particularized facsimile number for managing the incoming facsimiles 18 received by the server input 20. Specifically, each account holder is assigned a dedicated facsimile number that directs incoming electronic facsimiles 18 to the appropriate user account 28. The user account 28 may include personalized information regarding the user such as a designated e-mail address and a password, for example. It is understood that each of the user accounts 28 may have particularized password protection for limiting public access to the information stored in the user accounts 28. Although the database 26 is shown having six user accounts 28, it is understood that the database 26 may include any number of user accounts 28, as desired.

The account holder system 16 is in communication with the server system 14. The account holder system 16 may be any device or system adapted to communicate with the server system 14 through the internet such as, a computer terminal, for example. In certain embodiments, the account holder system 16 connects to the server system 14 through a web portal defined by the manager of the server system 14. Other methods of connection may be used, as desired.

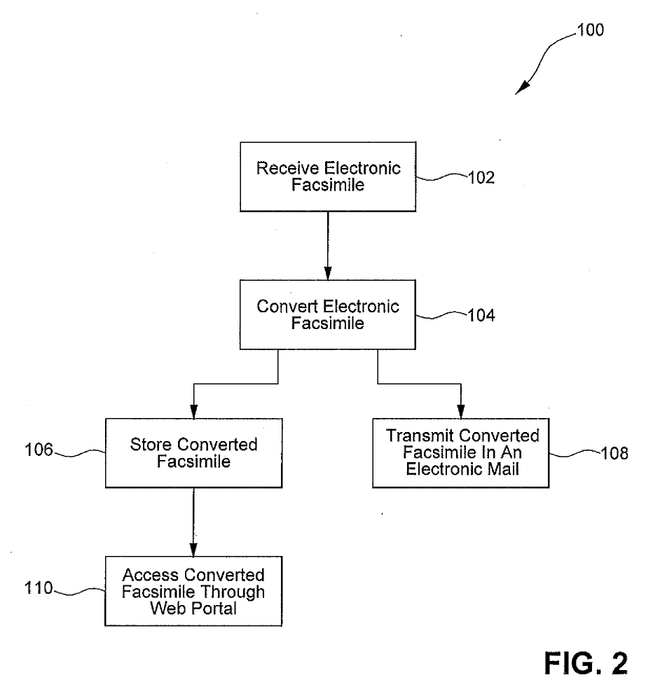

Referring to both FIGS. 1 and 2, a method 100 for receiving the electronic facsimile 18 according to one aspect of the invention will now be described. In step 102, the facsimile transmission system 10 receives the incoming facsimile 18 sent to an intended recipient having the associated user account 28 on the database 26 The facsimile 18 is received via the telephone line or the high speed internet line in communication with the server input 20. The incoming electronic facsimile 18 is received by the server input 20 as a Tagged Image File (TIF) and then converted to a Portable Document Format (PDF) using commercially available software, as shown in step 104. It is understood that the processor 22, in cooperation with storage system 24, may convert the incoming electronic facsimile 18 based upon the instruction set 23. In step 106, the PDF file is electronically stored to the user account 28 that is associated with the account of the intended recipient. In step 108, the PDF file can be forwarded to the account holder at an email address designated by the account holder. Additionally, the account holders can access the database 26 through a web portal, wherein each of the account holders may login to his or her user account 28 and view the stored PDF files, as shown in step 110. The facsimile transmission system 10 processes all incoming facsimiles 18 in the same manner; namely, converting an incoming facsimile 18 to a PDF file format, storing the PDF file in the associated user account 28, and forwarding the PDF file as an attachment to a predetermined email address.

The facsimile communication system 10 and method for receiving the electronic facsimile 18 provide access to the received electronic facsimile 18 to a desired account holder having access to the Internet. The facsimile communication system 10 provides a cost effective means for receiving the electronic facsimile 18 without the limitations of a conventional facsimile machine or a PC integrated with a fax modem.

From the foregoing description, one ordinarily skilled in the art can easily ascertain the essential characteristics of this invention and, without departing from the spirit and scope thereof, make various changes and modifications to the invention to adapt it to various usages and conditions.

What is claimed is:

1. A facsimile server system comprising:
a server input adapted to receive an electronic facsimile;
a processor adapted to convert the electronic facsimile into a converted facsimile having a desired format; and
a database adapted to store the converted electronic facsimile.

2. The facsimile server system according to claim 1, wherein the server input receives an electronic facsimile through at least one of a telephone line and a high speed internet line.

3. The facsimile server system according to claim 1, wherein the server input is an integrated fax card.

4. The facsimile server system according to claim 1, wherein the electronic facsimile is received by the server input in a Tagged Image File format.

5. The facsimile server system according to claim 1 wherein the electronic facsimile is converted by the processor into a Portable Document Format.

6. The facsimile server system according to claim 1, wherein the database includes a plurality of user accounts, and wherein the converted electronic facsimile is stored in an associated one of the user accounts.

7. The facsimile server system according to claim 6, wherein each of the user accounts is associated with a pre-determined facsimile number for receiving and storing the incoming electronic facsimiles.

8. The facsimile server system according to claim 1, wherein the processor transmits the converted electronic facsimiles to an electronic mailbox associated with a user account.

9. The facsimile server system according to claim 1, wherein an account holder accesses the database via a web portal to retrieve the stored electronic facsimiles.

10. A facsimile communication system comprising:
a facsimile device adapted to transmit an electronic facsimile;
a server system having a server input adapted to receive the electronic facsimile, a processor adapted to convert the electronic facsimile into a converted facsimile having a desired format and a database adapted to store the converted facsimile; and
a user system adapted to access the database for retrieving the converted facsimile.

11. The facsimile server system according to claim 10, wherein the server input receives an electronic facsimile through at least one of a telephone line and a high speed internet line.

12. The facsimile server system according to claim 10, wherein the server input is an integrated fax card.

13. The facsimile server system according to claim 10, wherein the electronic facsimile is received by the server input in a Tagged Image File format.

14. The facsimile server system according to claim 10, wherein the electronic facsimile is converted by the processor into a Portable Document Format.

15. The facsimile server system according to claim 10, wherein the database includes a plurality of user accounts, and wherein the converted electronic facsimile is stored in an associated one of the user accounts.

16. The facsimile server system according to claim 15, wherein each of the user accounts is associated with a pre-determined facsimile number for receiving and storing the incoming electronic facsimiles.

17. The facsimile server system according to claim 10, wherein the processor transmits the converted electronic facsimiles to an electronic mailbox associated with a user account.

18. The facsimile server system according to claim 10, wherein the user system accesses the database via the Internet.

19. A method for receiving an electronic facsimile, the method comprising the steps of:
transmitting an electronic facsimile having a Tagged Image File format;
providing a server system having a server input adapted to receive the electronic facsimile, a processor adapted to convert the electronic facsimile into a converted facsimile having a desired format and a web-accessible database adapted to store the converted facsimile;
converting the electronic facsimile into a converted facsimile having a Portable Document Format;
storing the converted facsimile on the database; and
transmitting the converted facsimile as an attachment in an electronic mail.

20. The method according to claim 19, wherein database includes a plurality of user accounts, and wherein the converted electronic facsimile is stored in an associated one of the user accounts.
